(19) United States
(12) Patent Application Publication
(10) Pub. No.: US 2002/0113632 A1
(43) Pub. Date: Aug. 22, 2002

(54) Chewing gum products including hydrogenated starch hydrolysates

(76) Inventors: Robert J. Yatka, Palos Park, IL (US); David G. Barkalow, Deerfield, IL (US); Lindell C. Richey, Lake Zurich, IL (US)

Correspondence Address: BELL, BOYD & LLOYD LLC, P. O. BOX 1135, CHICAGO, IL, 60690-1135, US

(21) Appl. No.: 09/735,054

(22) Filed: Dec. 11, 2000

Related U.S. Application Data
(60) Provisional application No. 60/171,245, filed on Dec. 16, 1999.

(51) Int. Cl. A23K 1/00

(52) U.S. Cl. 327/165

(57) ABSTRACT

Chewing gum products and methods for manufacturing same are provided. The gum includes a center having a water-soluble portion and a water-insoluble portion and including hydrogenated starch hydrolysate and no glycerin. A coating encloses the center.

This application is based on U.S. Provisional Patent Application Serial No. 60/171,245 filed on Dec. 16,1999.

### BACKGROUND OF THE INVENTION

The present invention relates generally to confectionary products. More specifically, the present invention relates to chewing gum products that include an outer shell or coating.

It is of course known to provide a variety of different types of confectionary products to consumers. Chewing gum is one such confectionary product. Chewing gums generally consist of a water-insoluble portion and a water-soluble portion that includes sweeteners.

In a similar vein, it is known to provide a variety of different types of chewing gum. For example, it is know that in producing chewing gum, and other confectionary products, to coat the chewing gum with an outer or over-coating. The over-coating can provide an initial sweetness or other desirable oleptic property to the consumer. The over-coating also provides, preferably, a smooth outer appearance to the consumer. A number of such chewing products are known.

In the first over-coated chewing gum products that were produced, sugar-syrups were used to create the over-coating. Sugar-syrup creates a product having a smooth appearance. When chewed by the consumer, a sugar-syrup provides a crunching sensation. Additionally, such a coating provides an initial burst of sweetness.

In recent years, efforts have focused on replacing sugar and sugar-syrups in chewing gum with other carbohydrates and non-carbohydrates. This has entailed not only replacing the sugar sweetener within the chewing gum, but also the sugar sweetener in the coating layers that are used in coating the chewing gums and other confectionary products For example, it has been known to use xylitol as an over-coating.

In making such sugarless chewing gum formulations, it has been known to use polyols and high levels of glycerin. Recently, formulations containing a hydrogenated starch hydrolysate type of syrup have been utilized in a pre-mix with glycerin to reduce the moisture content of the gum formulation. In order to create an acceptable textured center, in coated sugarless chewing gum products, high levels of glycerin have been used. However, such a chewing gum center formulation is very hydroscopic and absorbs moisture into the sugarless coating. This reduces the “crunchiness” of the coating. Thus, coated sugarless gum suffers a disadvantage in that it loses its crunch over the shelf-life. There is therefore a need for an improved coated chewing gum product.

### SUMMARY OF THE INVENTION

The present invention provides improved coated confectionary products and methods of manufacturing same.

To this end, in an embodiment, the present invention provides a chewing gum product comprising a center including a water-soluble portion and a water-insoluble portion. The center includes hydrogenated starch hydrolysate and no glycerin. A coating encloses the center.

In an embodiment, the center includes at lease one polyol.

In an embodiment, the center includes sorbitol.

In an embodiment, the coating includes hydrogenated isomaltulose (Isomalt).

In an embodiment, the coating includes xylitol.

In an embodiment, the product is sugarless.

In an embodiment, the chewing gum product contains no aqueous softeners other than hydrogenated starch hydrolysate.

In an embodiment, the center contains no liquid sorbitol.

In another embodiment, the present invention provides a chewing gum comprising a center that comprises a water-soluble portion and a water-insoluble portion, and includes at least one polyol, hydrogenated starch hydrolysate, and no glycerin, and a coating that encloses the center that is sugarless.

In yet a further embodiment, the present invention provides a method of manufacturing chewing gum. The method comprising the steps of producing a center having a water-soluble portion and a water-insoluble portion, and including hydrogenated starch hydrolysate and no glycerin, and coating the center with a sugarless coating.

In an embodiment, the center is coated using a hard coating panning procedure.

In an embodiment, the coating step includes a dry charging step.

An advantage of the present invention is that it provides an improved coated confectionary product.

Another advantage of the present invention is to provide an improved sugarless coated chewing gum product.

A further advantage of the present invention is to provide an improved confectionary having an over-coating.

Still further, an advantage of the present invention is to provide an improved method for manufacturing products having an over-coating.

Further, an advantage of the present invention is to provide an improved chewing gum formulation.

Moreover, an advantage of the present invention is to provide an over-coated sugarless chewing gum product that does not lose its crunch over time.

Furthermore, an advantage of the present invention is to provide an improved method for manufacturing chewing gum having an over-coating.

Additional advantages and features of the present invention are described in the detailed description of the presently preferred embodiments.

### DETAILED DESCRIPTION OF THE PRESENTLY PREFERRED EMBODIMENTS

The present invention provides improved over-coated confectionary products as well as methods for over-coating confectionary products. Although in the preferred embodiments set forth below the confectionary product is chewing gum, the present invention is not limited to chewing gum.

Generally, the present invention comprises the use of hydrogenated starch hydrolysate in the center of a soft chewing gum portion of the product, without the use of glycerin. Surprisingly, it has been found, that the use of hydrogenated starch hydrolysate without glycerin in a coated confectionary product, especially sugarless product, greatly improves the shelf-life of the product. In this regard, the gum center remains soft yet the over-coating remains hard affording a product that provides improved crunchiness.

Pursuant to the present invention, the chewing gum product includes an outer shell, and a soft gum center formulation that includes hydrogenated starch hydrolysate, but no glycerin. The gum center will typically include other polyols such as sorbitol. The formulation is then coated with a coating, preferably a sugarless coating (an example of such a coating is xylitol or Isomalt). It has been found that an improved coated gum product, e.g., pellet, is provided having good crunchiness throughout its shelf-life even at high humidity in accelerated storage conditions.

Hydrogenated starch hydrolysates are produced by the partial hydrolysis of corn, wheat, or potato starch and the subsequent hydrogenation of the hydrolysate at high temperature under pressure. The end product is an ingredient composed of sorbitol, maltitol, and higher hydrogenated saccharides (maltitol and others). By varying the conditions and extent of hydrolysis, the occurrence of various mono-, di-, oligo- and polymeric hydrogenated saccharides in the resulting product can be varied.

As used herein, hydrogenated starch hydrolysate is used to describe the broad group of polyols that contain substantial quantities of hydrogenated oligo- and polysaccharides in addition to any monomeric or dimeric polyols (sorbitol/mannitol or maltitol, respectively). This term does not differentiate polyols having, for example, different levels of sweetness nor does it identify the principle polyol.

As noted above, pursuant to the present invention, soft gum center formulations are provided that contain sorbitol, other polyols, and hydrogenated starch hydrolysate, but no glycerin. In an embodiment, the soft gum center contains no aqueous liquid sorbitol. The center formulations are then coated with a polyol such as Isomalt, xylitol, or maltitol and afford an improved-coated gum product, e.g., pellet, having good crunchiness throughout its shelf life; even in high humidity accelerated storage conditions. At medium to high levels of glycerin, Isomalt coated gum will have poor crunch and will quickly lose any such crunch. It has been surprisingly found that compared to coated gum with low levels of glycerin in the center, coated gum centers with hydrogenated starch hydrolysate and no glycerin remains soft and provides improved crunchiness.

Gum centers made with medium to high levels of glycerin are low in moisture content. These centers have a low water activity or an ERH (Equilibrium Relative Humidity) of approximately 0.25 to about 0.45 or 25 to 45% respectively. These formulas are hygroscopic and tend to absorb moisture even after the gum is coated. Gum center formulations made with aqueous liquid sorbitol are higher in moisture content, and have a water activity of approximately 0.65 to about 0.80 or 65 to 80% ERH. These centers have a tendency to dry out, so the center and coating become hard and brittle. Using a center with hydrogenated starch hydrolysate, no glycerin, and no liquid sorbitol, gives a sugarless center with good texture, water activity of approximately 0.50 to about 0.60 (50 to 60% ERH) and good shelf life stability after the gum center is coated.

Pursuant to the present invention, a variety of coated gum products can be manufactured. For example, pellet or ball gum could be prepared as conventional chewing gum, but formed into pellets that are pillow shaped or into balls. The pellets/balls can then be coated or panned to make coated pellet gum. The weight of the coating may be approximately 20% to about 50% of the weight of the finished gum product.

Conventional panning procedures generally coat the product with sucrose. However, advances in panning have allowed the use of other carbohydrate materials to be used in the place of sucrose. Some of these components include, but are not limited to, dextrose, and maltose, sugarless materials like xylitol, hydrogenated isomaltulose (Isomalt), maltitol, lactitol, and other new polyols or combinations thereof. These materials may be blended with panning modifiers including, but not limited to, gum arabic, maltodextrins, corn syrup, gelatin, cellulose type materials like carboxymethyl cellulose or hydroxymethyl cellulose, starch and modified starches, vegetable gums like alginates, locust bean gum, guar gum, and gum tragacanth, insoluble carbonates like calcium carbonate or magnesium carbonate, and talc. Antitack agents may also be added as panning modifiers, which allow the use of a variety of carbohydrates and sugar alcohols to be used in the development of new panned or coated gum products.

Chewing gum products of the present invention may be made using a variety of different compositions that are typically used in chewing gum compositions. In general, a chewing gum composition typically contains a chewable gum base portion which is essentially free of water and is water-insoluble, a water-soluble bulk portion and flavors which are typically water-insoluble. The water-soluble portion dissipates with a portion of the flavor over a period of time during chewing. The gum base portion is retained in the mouth throughout the chew. The insoluble gum base generally comprises elastomers, elastomer solvents, plasticizers, waxes, emulsifiers, and inorganic fillers. Plastic polymers, such as polyvinyl acetate, which behave somewhat as plasticizers, are also included. Other plastic polymers that may be used include polyvinyl laurate, polyvinyl alcohol, and polyvinyl pyrrolidone.

Elastomers may include polyisobutylene, butyl rubber, isobutylene-isoprene copolymer, and styrene butadiene rubber, as well as natural latexes such as chicle. Elastomer solvents are often resins such as terpene resins. Plasticizers, sometimes referred to as softeners, are typically fats and oils, including tallow, hydrogenated vegetable oils, and cocoa butter. Commonly employed waxes include paraffin, microcrystalline and natural waxes such as beeswax and carnauba. Microcrystalline waxes, especially those with a high degree of crystallinity, may be considered bodying agents or textural modifiers.

The gum base typically also includes a filler component. The filler component may be calcium carbonate, magnesium carbonate, talc, dicalcium phosphate or the like. The filler may constitute between approximately 5% to about 50% of the gum base.

Emulsifiers, which sometimes also have plasticizing properties, include glycerol monosterate, lecithin, and glycerol triacetate. Further, gum bases may also contain optional ingredients such as antioxidants, colors, and flavors.

The insoluble gum base may constitute between approximately 5% to about 95% of the gum. Typically, the insoluble gum base may comprise between approximately 10% and about 50% of the gum, or from approximately 20% to about 40% of the gum. The present invention contemplates employing any commercially acceptable gum base. The water-soluble portion of the chewing gum may further comprise softeners, sweeteners, flavoring agents, and combinations thereof. The sweeteners often fulfill the role of bulking agents in the gum. The bulking agents typically comprise approximately 5% to about 95% of the gum composition.

Softeners are added to the chewing gum in order to optimize the chewability and mouth feel of the gum. Softeners, also known in the art as plasticizers or plasticizing agents, generally constitute between approximately 0.5% to about 15% of the chewing gum. Softeners contemplated by the present invention include, for example, lecithin. Further, aqueous sweetener solutions such as those containing sorbitol, hydrogenated starch hydrolysate, corn syrup and combinations thereof may be used as softeners and binding agents in gum.

The gum center formulation of the present invention is preferably a sugar-free gum formulation. However, sugar-gum formulations may also be manufactured pursuant to the present invention. Sugar sweeteners generally include saccharide-containing components commonly known in the chewing gum art which comprise, but are not limited to, sucrose, fructose, levulose, galactose, corn syrup solids and the like, alone or in any combination. Generally, sugarless sweeteners include components with sweetening characteristics, but, which are devoid of the commonly known sugars. Such sugarless sweeteners are sorbitol, mannitol, xylitol, hydrogenated isomaltulose, maltitol, and the like, alone or in any combination.

Depending on the particular sweetness release profile and shelf stability required, coated or uncoated high intensity sweeteners may be used in chewing gum composition. High intensity sweeteners, such as aspartame, may be used at levels from approximately 0.01% to about 3.0%. Encapsulated aspartame is a high intensity sweetener with improved stability and release characteristics, as compared to free aspartame. Free aspartame can also be added, and a combination of some free and encapsulated aspartame can be used.

Flavors may be present in the chewing gum in an amount within the range from approximately 0.1% to about 10% and typically constitute from approximately 0.5% to about 0.3% of the gum. Flavors contemplated by the present invention include any liquid flavoring that is of food acceptable quality. The flavor may comprise essential oils, synthetic flavors, or mixtures thereof, including, but not limited to, oils derived from plants and fruits such as citrus oils, fruit essences, peppermint oil, spearmint oil, clove oil, oil of wintergreen, anise, and the like. Artificial flavoring components are also contemplated by the present invention. Those of ordinary skill in the art will recognize that natural and artificial flavors may be combined in any sensorally acceptable blend. All such flavors and blenders are contemplated by the present invention.

Optional ingredients such as colors, emulsifiers, and pharmaceutical agents may also be added as separate components of the chewing gum composition, or added as part of the gum base.

A method of manufacturing chewing gum according to the present invention is by sequentially adding the various chewing gum ingredients to any commercially available mixer known in the art. After the ingredients have been thoroughly mixed, the gum base is discharged from the mixer and shaped into the desired form such as by rolling into sheets and cutting into sticks, extruding into chunks, or casing into pellets.

Generally, the ingredients are mixed by first melting the gum base and adding it to the running mixer. The base may also be melted in the mixer itself Colors or emulsifiers may also be added at this time. A softener may be added to the mixer at this time, along with syrup and a portion of the bulking agent. Flavor is typically added with the final portion of the bulking agent. Other optional ingredients are added in the batch in a typical fashion, well known to those of ordinary skill in the art.

The coating may contain ingredients such as flavoring agents, artificial sweeteners and dispersing agents, coloring agents, film formers and binding agents. Flavoring agents contemplated by the present invention include those commonly known in the art such as essential oils, synthetic flavors, or mixtures thereof, including, but are not limited to, oils derived from plants and fruits such as citrus oils, fruit essences, peppermint oil, spearmint oil, other mint oils, clove oil, oil of wintergreen, anise and the like. The flavoring agents may be added to the coating syrup in an amount such that the coating will contain from approximately 0.2% to about 1.2% flavoring agent, and typically constitute from approximately 0.7% to about 1.0% flavoring agent.

Artificial sweeteners, particularly high intensity sweeteners, contemplated for use in the coating include, but are not limited to, synthetic substances, saccharin, thaumatin, alitame, saccharin salts, aspartame, sucralose, and acesulfame-K. The artificial sweetener may be added to the coating syrup in an amount such that the coating will contain from approximately 0.05% to about 1.0%, and typically from approximately 0.10% to about 0.5%, artificial sweetener.

Dispersing agents are often added to syrup coatings for the purpose of whitening and tack reduction. Dispersing agents contemplated by the present invention to be employed in the coating syrup include titanium dioxide, talc, or any other antistick compound. The dispersing agent may be added to the coating syrup in an amount such that the coating will contain from approximately 0.1% to about 1.0%, and typically from approximately 0.3% to about 0.6% of the agent.

Coloring agents may be added directly to the coating syrup in dye or lake form. Coloring agents contemplated by the present invention include food quality dyes.

Film formers that may be added to the coating syrup include methyl cellulose, carboxymethyl cellulose, ethyl cellulose, hydroxyethyl cellulose, carboxymethyl cellulose and the like and combinations thereof.

Binding agents may be added either as an initial coating on the chewing gum center or may be added directly to the coating syrup. Binding agents contemplated by the present invention include gum arabic, gum talha, gelatin, vegetable gums, and the like. The binding agents, when added to the coating syrup, are typically added at a level of between approximately 0.5% to about 10%.

Typically, the coating process is carried out in a rotating pan. Gum center tablets to be coated are placed into the rotating pan to form a moving mass. The material or syrup, which will eventually form the coating, is applied or distributed over the gum tablets. Flavoring agents may be added before, during and after applying the syrup to the gum centers. Once the coating has been dried to form a hard surface, additional syrup additions can be made to produce a plurality of coatings or multiple layers of hard coating.

In an embodiment, in the hard coating panning procedure, the polyol syrup is added to the gum center tablets at a temperature range from approximately 100_F to about 200_F. Alternatively, the syrup temperature may be from approximately 120_F to about 170_F. The syrup temperature may be maintained throughout the process at a specific temperature so as to prevent the polyol in the syrup from crystallizing. For hydrogenated isomaltulose suspension syrups, the syrup temperature will generally be maintained at approximately 130 to about 136_F. The syrup may be mixed with, sprayed upon, poured over, or added to the gum center tablets in any manner known to those skilled in the art.

Pursuant to the present invention, each component of the coating on the gum center tablets may be applied in a single hard layer or in a plurality of hard layers. In general, a plurality of layers is obtained by applying single coats, allowing the layers to dry, and then repeating the process. The amount of solids added by each coating step depends chiefly on the concentration of the coating syrup. Any number of coats may be applied to the chewing gum center tablet. Typically, approximately 30 to about 60 coats are applied. In any event, a sufficient number of coats are applied to yield a hard-coated chewing gum or other comestible product, typically containing approximately 10% to about 65% coating. For chewing gum, the final product may contain from approximately 20% to about 50% hard coating.

Those skilled in the art will recognize that in order to obtain a plurality of hard coated layers, a plurality of premeasured aliquots of coating syrup may be applied to the gum center tablets. It is contemplated, however, that the volume of aliquots of syrup applied to the gum center tablets may vary throughout the coating procedure.

The present invention contemplates that a flavoring agent may be added to the syrup, or applied to the gum center tablets, while the syrup coating is drying or after the coating has dried. Furthermore, the flavoring agent may be applied anywhere within the sequence of coats, for example, after the third, twelfth, eighteenth, etc., coats.

Once a coating of syrup is applied to the gum center tablets, in an embodiment the present invention contemplates drying the wet syrup in an inert medium. A preferred drying medium usually comprises air. Typically, forced drying air contacts the wet syrup coating in a temperature range of approximately 75_F to about 1 1 5_F. Usually, drying air in the temperature range from approximately 80_F to about 100_F is used. Typically, the drying air possesses a relative humidity of approximately 5 to about 25%.

The drying air may be passed over and admixed with the syrup coated gum centers in any manner known in the art. The drying air may be blown over and around the syrup coated gum center at a flow rate, for large-scale preparations, of about 2800 cubic feet per minute. If lower quantities of material are being processed, or if smaller equipment is used, lower flow rates would be used. If a flavoring agent is applied after syrup coating has been dried, the present invention contemplates drying the flavoring agent with or without the use of a drying medium.

The present invention may use a dry charging step along with the use of the suspension syrup in the coating process. Dry charging is used to reduce the stickiness of the syrup applications. Generally, several alternating steps of applying a first coating syrup then a powder material are used. An important part of this first stage of the coating process is that the first coating syrup completely covers the centers, and then applying powder material in sufficient quantity to make a smooth coating. Dry charging is generally used with maltitol, sorbitol, lacotitol, and Isomalt coatings but not with xylitol.

In another embodiment of the present invention, a syrup suspension using Isomalt may be used in the coating process without the need for a dry charge. As noted earlier, a dry charge is generally used to help dry the liquid application and reduce sticking of the pellets together or to the side of the coating pan during the coating operation. Other methods to reduce sticking during coating are to significantly reduce the amount of liquid coating applied per application and use in the latter stages of coating if a smoother product is desired.

By way of example, and not limitation, examples of the present invention will now be given.

### EXAMPLES

The following gum formulas were made into pellets for coating:

| | Comparative | Inventive | Comparative |
|---|---|---|---|
| Ingredients | (Example 1) | (Example 2) | (Example 3) |
| Sorbitol | 41.00% | 39.50% | 35.00% |
| Base | 32.00 | 30.00 | 30.50 |
| Calcium Carbonate | 15.00 | 15.00 | 15.00 |
| Hydrogenated Starch | — | 6.00 | — |
| Hydrolysates | | | |
| Glycerin | 1.00 | — | 2.00 |
| Encapsulated | 3.00 | 3.00 | 3.00 |
| Menthol | | | |
| Mannitol | — | 5.00 | 9.00 |
| Sorbitol Liquid | 6.50 | — | 4.00 |
| Encapsulated | 0.50 | 0.50 | 0.50 |
| Sweeteners | | | |
| Flavor | 1.00 | 1.00 | 1.00 |
| Total | 100.00% | 100.00% | 100.00% |
| | Inventive | Inventive | Inventive |
| Ingredients | (Example 4) | (Example 5) | (Example 6) |
| Sorbitol | 33.00% | 34.00% | 37.00% |
| Base | 32.50 | 33.50 | 33.50 |
| Calcium Carbonate | 12.00 | 15.00 | 9.50 |
| Hydrogenated Starch | 8.50 | 5.00 | 7.00 |
| Hydrolysates | | | |
| Glycerin | — | — | — |
| Encapsulated | 3.00 | — | 4.00 |
| Menthol | | | |
| Mannitol | 9.00 | 10.00 | 7.00 |
| Maltitol | — | — | 0.50 |
| Encapsulated | 0.50 | 0.75 | 0.50 |
| Sweeteners | | | |
| Flavor | 1.50 | 1.75 | 1.00 |
| Total | 100.00% | 100.00% | 100.00% |

All Examples were coated on a Driam Driacoater Model DRC600 using a center load of 12Kg. For the finishing syrup, Isomalt powder was mixed into water at about 90_C, the other ingredients were added, and reheated and held at 70_C until used for coating. A suspension syrup may be prepared by dissolving hydrogenated isomaltulose powder in water and heating to 90_C to make a solution. The solution is then heated and cooled with the addition of the gum talha solution and other ingredients to about 55_C (131_F). Powdered hydrogenated isomaltulose is added to form a suspension. This mixture is then held at 55_C for coating. The powdered hydrogenated isomaltulose may have a particle size such that 90% of the material is less than 100 microns. A suspension syrup of about 72% solids may be used throughout the coating process without the use of a finishing syrup.

The following syrup composition was used to coat the Examples listed above:

| | Coating Suspension | Finishing |
|---|---|---|
| | Syrup | Syrup |
| Water | 24.10% | 28.00% |
| Hydrogenated Isomaltulose | 42.50 | 65.40 |
| (Isomalt) | | |
| Titanium Dioxide | 0.90 | 0.90 |
| 40% Gum Talha Solution | 5.50 | 5.20 |
| Powder Hydrogenated | 26.50 | — |
| Isomaltulose | | |
| High-Intensity Sweetener | 0.40 | 0.40 |
| Color | 0.10 | 0.10 |
| Total | 100.00% | 100.00% |

Pellets were coated with about 40 to 50 syrup applications with air drying between each application. Air-drying conditions were about 30_C and about 25% RH. Dry charging was done within the first 10 to 22 applications, and flavor was added in several of the next 20 to 30 applications. The coating suspension syrup was used in about the first 40 syrup applications. The finishing syrup was used in the next 6-8 applications to give a smooth coated product. Coating was applied to pellets that weigh about 1.04 grams per piece until a piece weight of 1.52 grams per piece was obtained, which is a 31.5% coating. Pellets were polished with carnauba wax.

After samples were about 3 weeks old, an accelerated aging test was conducted for Examples 1, 2, and 3. Samples remained unpackaged and stored in a chamber of 70% relative humidity and a constant temperature of 85_F. Trained sensory technicians evaluated the samples for crunch at different time intervals. The results are as follows:

| Sample # | T = 0 | T = 20 | T = 26 | T = 37 | T = 46 | T = 81 |
|---|---|---|---|---|---|---|
| Example 1 | 4 | 2.5 | 3 | 3 | 3.5 | 3 |
| Example 2 | 4 | 4 | 4 | 4 | 4.5 | 4.5 |
| Example 3 | 4.5 | 3 | 1.5 | 1.5 | 1.5 | 1.0 |

* (T = the number of days in an accelerated aging chamber)
* Sensory bench level, 1 = no crunch, 5 = highest crunch

Trained sensory technicians verified that the inventive samples were similar to the comparative samples in attributes such as flavor, texture, aroma, etc., but identified that the inventive sample containing the hydrogenated starch hydrolysates had a superior crunch especially over time. Although not tested, Examples 4, 5, and 6 may yield similar results after the same analysis.

Instron data was also collected from Examples 1, 2, and 3. These samples were measured for their initial hardness at certain time intervals. Samples were measured by driving a needle into them to a depth of 0.10 inches at a speed of 0.2 inches per minute to generate a characteristic stress/strain curve. The maximum height (maximum load) of the curve is proportional to the work done in penetrating the pellet coating and is a measure of the initial hardness of the pellet coating.

The results are as follows:

| Sample # | T = 26 | T = 37 | T = 46 | T = 81 |
|---|---|---|---|---|
| Example 1 | 1.19 | 1.34 | 1.46 | 1.26 |
| Example 2 | 1.40 | 1.52 | 1.57 | 1.44 |
| Example 3 | 0.76 | 0.74 | 0.83 | 0.58 |

*(T = number of days in an accelerated aging chamber)

In comparing the sensory and Instron data from above, Example 2 (containing the hydrogenated starch hydrolysates) is superior in maintaining the integrity of the pellet crunch. Examples, 4, 5, and 6 may yield similar results after analysis.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

We claim:

1. A chewing gum product comprising:
a center including a water-soluble portion and a water-insoluble portion;
the center including hydrogenated starch hydrolysate and essentially no glycerin; and
a coating that encloses the center.

2. The chewing gum product of claim 1 wherein the center includes at least one polyol.

3. The chewing gum product of claim 1 wherein the center includes sorbitol.

4. The chewing gum product of claim 1 wherein the coating includes hydrogenated isomaltulose.

5. The chewing gum product of claim 1 wherein the product is sugarless.

6. The chewing gum product of claim 1 wherein the center does not include liquid sorbitol.

7. The chewing gum product of claim 1 wherein the center does not include other aqueous softeners.

8. A chewing gum comprising:
a center that includes a water-soluble portion and a water-insoluble portion, and includes at least one polyol, hydrogenated starch hydrolysate, and no glycerin; and
a coating that encloses the center that is sugarless.

9. The chewing gum product of claim 8 wherein the center includes sorbitol.

10. The chewing gum product of claim 8 wherein the coating includes hydrogenated isomaltulose.

11. The chewing gum product of claim 8 wherein the center does not include liquid sorbitol.

12. The chewing gum product of claim 8 wherein the center does not include other aqueous softeners.

13. A method of manufacturing chewing gum comprising the steps of:
producing a center having a water-soluble portion and a water-insoluble portion, and including hydrogenated starch hydrolysate and no glycerin; and
coating the center with a sugarless coating.

14. The method of claim 13 wherein the center is coated using a hard coating panning procedure.

15. The method of claim 13 wherein the coating step includes a dry charging step.

16. The method of claim 13 wherein the center includes at least sorbitol.

17. The method of claim 13 wherein the coating includes hydrogenated isomaltulose.

18. The chewing gum product of claim 13 wherein the center does not include liquid sorbitol.

19. The chewing gum product of claim 13 wherein the center does not include other aqueous softeners.

20. The method of claim 13 wherein the center is sugarless.
